(19) United States
(12) Patent Application Publication
(10) Pub. No.: US 2007/0021149 A1
(43) Pub. Date: Jan. 25, 2007

(54) Globaly applied technology enhanced or "GATE"

(76) Inventor: Ali Reza Abbassikhah, Los Angeles, CA (US)

Correspondence Address: ALI ABBASSI, POST OFFICE BOX 35501, LOS ANGELES, CA, 90035, US

(21) Appl. No.: 11/183,099

(22) Filed: Jul. 18, 2005

(51) Int. Cl. H04B 1/38; H04M 1/00

(52) U.S. Cl. 455/558

(57) ABSTRACT

The GATE System is an advanced new concept in that cellular handsets will work simultaneously with multiply installed SIM Cards. The handsets will have: a) multi and simultaneous service, b) multi and simultaneous service providers, and c) multiple functionalities, WITHOUT DISABELING ANY OF THE NUMBERS AND OR SERVICE. YOU CAN NOW HAVE MULTIPLE USES OF YOUR CELL PHONE AT THE SAME TIME BY SWITCHING BETWEEN NUMBERS FROM A TOUCH SCREEN OR THE KEYPAD!

### CROSS-REFERENCE TO RELATED APPLICATIONS

Not Applicable

### FEDERALLY SPONSORED RESEARCH

Not Applicable

### REFERENCE TO SEQUENCE LISTING and or CD APENDIX

Not Applicable

### BACKGROUND OF THE INVENTION

### Field of Invention

At the present time, cellular service, specifically GSM (Global Systems Mobile) works from cell sites that transmit at a specific frequency. Cell phones have what is known as a SIM (System Identification Module) Card. This particular card is designed to read, understand, and or pick up one carrier's frequency, and no other. The inherited problem is, if you have service provided by one carrier/provider, and you travel to an area (usually another country), your phone, in most cases will not work, as the current carrier/provider does not, or cannot provide service in the new area. The problem: if you need a phone number in the new area, and want to keep your previous number active, you now, with today's technology/system, would need a second phone. If you need three numbers, you would need three handsets, and so on. Another problem that cellular users face: if using the cellular handset for a laptop wireless internet connection, this same handset cannot be used for a telephone call at the same time. Another handset is now required, or, one would have to disconnect from the internet to place a call, or vice versa. Another problem that cellular users face: if you have a business, and need a personal phone number along, with a business phone number, you need two handsets, especially if you want or need another carrier/provider. These are just a few of the samples of problems faced by cellular users with today's current technology.

### INVENTION SUMMARY

The GATE System now provides cellular phone users with the capability of being able to use one instrument and have MULTIPLE PHONE NUMBERS with more than one cellular carrier or service provider on the SAME, ONE HANDSET. This allows one to multi-task using the wireless communication industry on one single handset. Therefore, the problem of multiple phone numbers, using a single handset, is now solved with this new technology. For example, with this service, you can now use the wireless feature of your laptop for connectivity, while talking on the same cellular phone simultaneously.

Some other examples of the benefits of this service are: 1) a cellular service subscriber can have both a personal number and a business number on the same phone, and talk to both parties without having to disconnect one of the numbers that is in use, 2) a cellular service subscriber traveling can have both his local number from his home country and a local number from the country to which he has traveled to, or, 3) any combination thereof. TAKE NOTE: While the wireless industry has attempted to provide some cellular handsets that contain two numbers, the problem they face is that one of the numbers has to be deactivated or shut off while the other one is in use. In addition to the deactivation requirement, you cannot have multiple carriers active on the same handset. The closest you can come to this new concept now, would be to physically open the phone, and then change at least one part, and that is if the phone could even accommodate this option.

### DESCRIPTION OF THE DRAWINGS

No drawings required/Not Applicable

### DETAILED DESCRIPTION

Mr. Abbassikhah's advanced new concept is that cellular handsets will work simultaneously with multiply installed SIM Cards. The handsets will have: a) multi and simultaneous service, b) multi and simultaneous service providers, and c) multiple functionalities, WITHOUT DISABELING ANY OF THE NUMBERS AND OR SERVICE. YOU CAN NOW HAVE MULTIPLE USES OF YOUR CELL PHONE AT THE SAME TIME BY SWITCHING BETWEEN NUMBERS FROM A TOUCH SCREEN OR THE KEYPAD!

Also it should be noted that this new design initiates several SIM Cards for the same handset, giving the cellular subscriber numerous options as to how many cellular numbers and providers he or she has available on one single hand set, being able to use them without disconnecting from any, but simply switching over. Using the Internet as an example of this new concept, today, you can have more than one site, or page up, and running, then open another site or page, and another, so on and so forth, switching between them without disconnecting or closing any of them. This is what the GATE system will do for the telecommunications industry.

The benefits to the subscriber are immense, and in line with the goal of cellular to replace landline phone sets, with the implementing of this system, the subscriber can have both his/her home phone number, a business number, and any other number or numbers they may want or need, without the cumbersome issue of having several handsets to accomplish this task.

In addition to the fact that this concept is introducing to the cellular industry and its' subscribers a Multi-SIM handset, the other novel part of the GATE system, is the fact that the subscriber will be able to discern, when the phone rings, which SIM Card, carrier, or region the call has originated from by reading a notification on the screen which indicates this described information. Or in other words, each active number would not just have the current caller ID info as it presently works and is possibly patented, but in addition to this feature, for those clients that have service from other countries/areas, when an incoming call is received, the phone would also show where the number originated from. The phone will have drop down window/screens with tabs at the bottom of the window/screen that allows the subscriber to see which line is ringing, select that window/screen, and then view the information programmed for that screen, for example: caller identification, region call originated from, callers name, etc.

This will work as this design now renders the phone as being MULTIPLE LINE CAPABLE, reading more than one SIM Card at the time. Again, for emphasis: the cellular user can choose which card and or cell number to use while the other one or ones are still active. This is of course is not to state that a cellular customer must choose multiple numbers or carriers, but they now have this option available.

Current cellular phones work with one SIM Card. This card can be exchanged, allowing the user to use another service provider, only if the new service provider is on the same MhZ. You must understand, that the cellular handset can pick up most frequencies as transmitted by the service providers. The phone will not work, as a part is required to allow the transmitting service provider access to that particular phone, or that phone needs access to a specific service provider. That part is called a SIM Card. When inserted into the phone, what is known as a reader, (similar to the way a credit card, along with the credit card machine work), reads the encoded data as provided by the service provider. This now “allows” that particular handset to receive the specific frequency of the service provider's transmission, and in turn send its signal back. Opening a line of communication, one note, the SIM Card must be activated by the carrier. As stated above, this allows for a limited use.

To better explain: an AM radio, will pick up all of the stations broadcasting on the AM frequency, even though FM signals are also present. As the radio is designed ONLY for the AM Mhz/frequency, it will never pick up a FM broadcast. The converse is true of the FM radio. Even though that same radio is surrounded by AM signals, it will never pick up the AM stations.

Now enters the radio that can pick up both the AM and FM frequencies. There are also radio units that also can tune in television frequencies in addition to the AM/FM stations. To listen to any one of the broadcasts or stations, you simply tune the radio to the desired frequency. You do not have to turn the unit off and change any internal parts.

This describes the total concept of the herein described multi-SIM capable cellular phone. By its design, additional readers and the capacity to hold the additional SIM cards will now allow the user to have not just additional phone numbers on one handset, but also allow the user to do so, as is the case with the radio, by simply selecting the service so desired, but as stated before, UNLIKE the radio, the user would be able to use any or all of the different services at the SAME TIME by simply selecting which service, or services the user wants.

What is claimed as being new, and desired to be protected by Utility Patent of the United States, is as follows:

1. Mr. Ali Reza Abbassikhah's advanced new invention that cellular handsets will work with multiply installed SIM cards simultaneously.

2. The handsets will have: a) multi and simultaneous service, b) multi and simultaneous service providers, and c) multiple functionalities, WITHOUT DISABELING ANY OF THE NUMBERS AND OR SERVICE. YOU CAN NOW HAVE MULTIPLE USES OF YOUR CELL PHONE AT THE SAME TIME BY SWITCHING BETWEEN NUMBERS FROM A TOUCH SCREEN OR THE KEYPAD!

3. The new invention and concept behind this technology is the Multi-use, multi-capable SIM-Card capable phone, providing cellular phone users with the capability of being able to use one instrument and have multiple phone numbers with more than one cellular carrier or service provider on this SAME, ONE INSTRUMENT.

4. This allows one to multi-task using the wireless telecommunication industry on one handset. The problem of multiple phone numbers, using a single handset, is now solved with this new invention.
